(19) United States
(12) Patent Application Publication
(10) Pub. No.: US 2011/0088852 A1
(43) Pub. Date: Apr. 21, 2011

(54) Window Curtain

(75) Inventors: Wem-Hsing Hu, Changhua County (TW); Sheng-Ying Hsu, Changhua County (TW)

(73) Assignee: CHING FENG HOME FASHIONS CO., LTD., Changhua County (TW)

(21) Appl. No.: 12/645,467

(22) Filed: Dec. 22, 2009

(30) Foreign Application Priority Data
Oct. 20, 2009 (TW) 098219281

(51) Int. Cl. A47H 23/00; E06B 9/24

(52) U.S. Cl. 160/84.05

(57) ABSTRACT

A window curtain includes a blind body, a curtain cover, and a connecting unit provided for operatively attaching the curtain cover to the blind body. The blind body is formed by a plurality of honeycomb shaped blind element and a controlling cord extending through the blind elements to controllably and foldably operate the blind body between an extended and folded position. The connecting unit has one or more connection parts being selectively provided at the blind elements at regular intervals between the top and bottom of the blind body, so that the curtain cover being attached to the blind body via the connection parts to define a plurality of sections of the curtain cover. Thus, the curtain cover is able to be controllably operated via the blind body in a cordless manner to increase the safety and enhance the aesthetic of the window curtain.

### BACKGROUND OF THE PRESENT INVENTION

1. Field of Invention

The present invention relates to window blind, and more particularly to a Roman blind, wherein a blind controlling cord is provided in the blind structure in a hidden manner for controllably operating the Roman blind, so as to enhance the safety feature thereof.

2. Description of Related Arts

Window blind is a common indoor decoration provided for shading, protecting privacy, and decorating purposes. In general, the folding operation of the blind is either horizontally or vertically. For the horizontally folding operation of the window blind, a controlling cord is actuated for driving the blind to move horizontally from side to side so as to complete the opening operation of the window blind. The blind may also be manually operated by the user directly moving the curtains left and right to complete the horizontal operation of the window blind. For the vertically folding operation of the window blind, the blind is provided between the upper and lower supporting members, wherein the lower supporting member is moved for operatively controlling the vertical operation blind to move between an opened and closed position, so as to adjustably control the shading and projecting light through the blind.

Accordingly, most of the vertically operating window blinds, such as Roman blind, normally have a curtain downwardly hanging at the upper supporting member, wherein the curtain is controlled by a controlling cord for manually and extendably moving between an opened and closed position.

Another common vertical window blind, such as closed type window blind, has a plurality of honeycomb shaped hollow slats seriously and continuously connecting one to another, wherein the honeycomb shaped hollow slats are able to foldably extend between an extending position and folding position via the honeycomb shaped hollow slats.

### SUMMARY OF THE PRESENT INVENTION

As mentioned above, the existing Roman blind has the controlling cord hanging out of the blind for extendably operating the blind between an opened and closed position. The exposed controlling cord not only reduces the aesthetic feelings of the blind, but also causes the potential dangerous, such as the cord may accidentally wind around a child neck to cause serious damage or even to death. The other existing closed type window blind having the plurality of honeycomb shaped hollow slats is unable to provide a relatively more aesthetics of the window blind and can hardly changing the appearance thereof. This type of window blind is unable to enhance the needs of decoration of the window blind. Therefore, the present invention provides a window curtain, wherein the curtain cover is provided for being operatively controlled in a cordless manner and meanwhile, is able to provide a variety of appearances of the window curtain to enhance the aesthetic feeling thereof. A plurality of second connection parts are provided for attaching the curtain cover with the blind body, so that the curtain cover is able to couple with the blind body for decorating and for hiding the controlling cord of the window curtain. The second connection parts may also enable the curtain cover detachably coupling with the blind body for detaching the curtain therefrom, so that the curtain cover is able to be conveniently detached and assembled for cleaning or other purposes, so as to enhance the safety and the functionality thereof.

Accordingly, the present invention provide a window curtain, which comprises a blind body, one or more curtain cover, and a connecting unit, wherein the blind body is formed via a plurality of honeycomb shaped blind elements, each of which is able to be foldably and extendably operated for controlling the window curtain. An elongated upper supporting mount is provided at a top of the blind body. A controlling cord is hanging from the upper supporting mount to extend through each of the honeycomb shaped blind elements, so that the controlling cord is able to lift up and drop down the honeycomb shaped blind elements to extend and fold the honeycomb shaped blind elements. The upper part of the curtain cover is connected with the upper supporting mount and the lower part of the curtain cover is fixed at a bottom portion of the blind body, wherein a weighing object having a predetermined weight is provided at a bottom portion of the blind body to operatively connect to the lower part of the curtain cover, so that the blind body is able to be upwardly pulled for controllably operating the blind body of the window curtain. In other words, the connecting unit comprises a first connection part and a second connection part, wherein the first connection part is provided between the upper supporting mount and the upper part of the curtain cover, such as a fastener of Velcro having a hook strip and a loop strip provided at the upper supporting mount and the upper part of the curtain cover for detachably coupling therewith. The second connection part is provided between the curtain cover and the honeycomb shaped blind elements of the blind body. For example, the second connection part comprises one or more elongated sticks, and a plurality of interlocking elements for positioning and coupling the curtain cover at the blind body. The elongated sticks may be spacedly provided along the horizontally arranged honeycomb shaped blind elements every predetermined interval of the blind body; the interlocking members are preferably C-shaped for interlocking with corresponding elongated sticks to sandwich the curtain cover therebetween to fixedly couple the curtain cover at the blind body. The lowest part of the curtain cover may cover the weighing object at the bottom portion of the blind body, such as via sewing, to fixedly coupling thereat. Another example of the second connection part is sewing the curtain cover at the certain blind elements of the blind body, and sewing the lowest part of the curtain cover with the weighing object to coupling the curtain cover at the bottom portion of the blind body. Therefore, when the weighing object is being pulled to extend or fold the honeycomb shaped blind elements of the blind body, the curtain cover is synchronizing with the honeycomb shaped blind elements of the blind body to move between the extended position and the folded position. The curtain cover is not only able to provide a variety of styles, such as patterns, shapes, or colors of the curtain cover, for decorating the window curtain, but also hiding the controlling cord of the window curtain, so as to increase the safety of home environment.

Therefore, the main objective is to provide the window curtain, which is able to operatively controlling the curtain cover in a cordless manner via hiding the controlling cord within the blind body, so as to enhance the aesthetic feelings of the window curtain and improve the safety of the traditional disadvantage of exposed controlling cord of a window curtain.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a window curtain according to a first preferred embodiment of the present invention.

FIG. 2 is an exploded perspective view of the window curtain according to the first preferred embodiment of the present invention.

FIG. 3 is a sectional view of the window curtain according to the first preferred embodiment of the present invention.

FIG. 4 is a perspective view of a window curtain according to a second preferred embodiment of the present invention.

FIG. 5 is an exploded perspective view of the window curtain according to the second preferred embodiment of the present invention.

FIG. 6 is a sectional view of the window curtain according to the second preferred embodiment of the present invention.

FIG. 7 is another sectional view of the window curtain according to the second preferred embodiment of the present invention.

FIG. 8 is an exploded perspective view of a window curtain according to a third preferred embodiment of the present invention.

FIG. 9 is a sectional view of the window curtain according to the third preferred embodiment of the present invention.

FIG. 10 is another sectional view of the window curtain according to the third preferred embodiment of the present invention.

### DETAILED DESCRIPTION OF THE PREFERRED EMBODIMENT

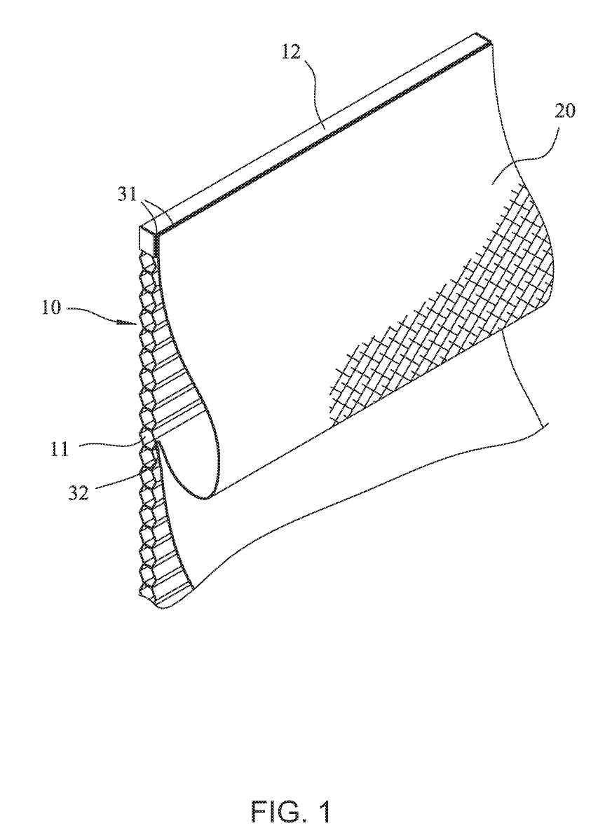

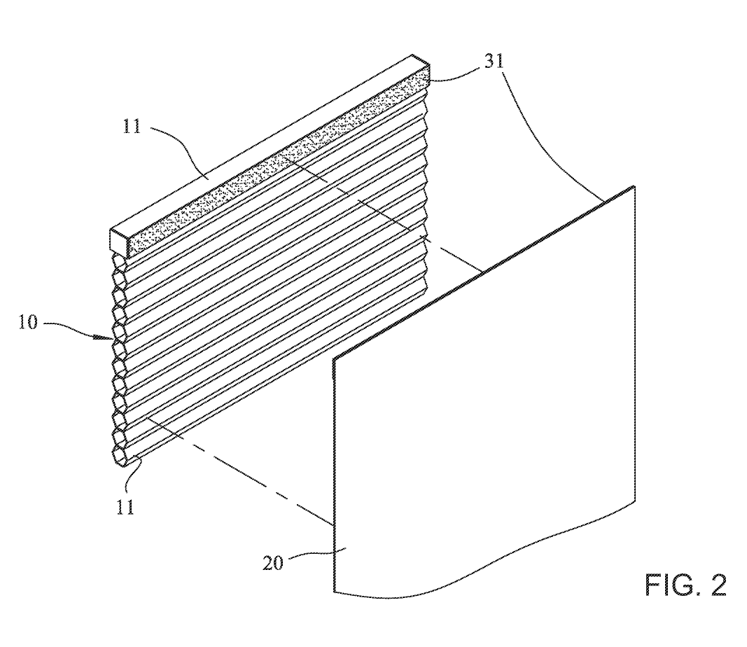

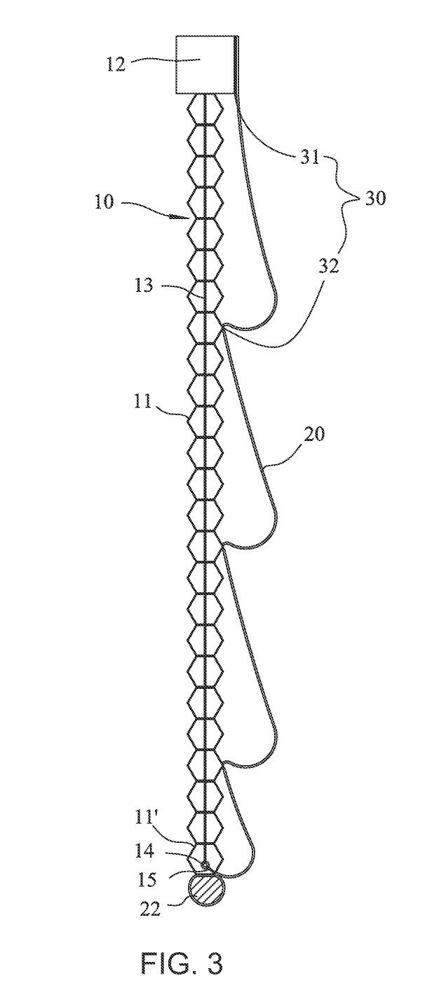

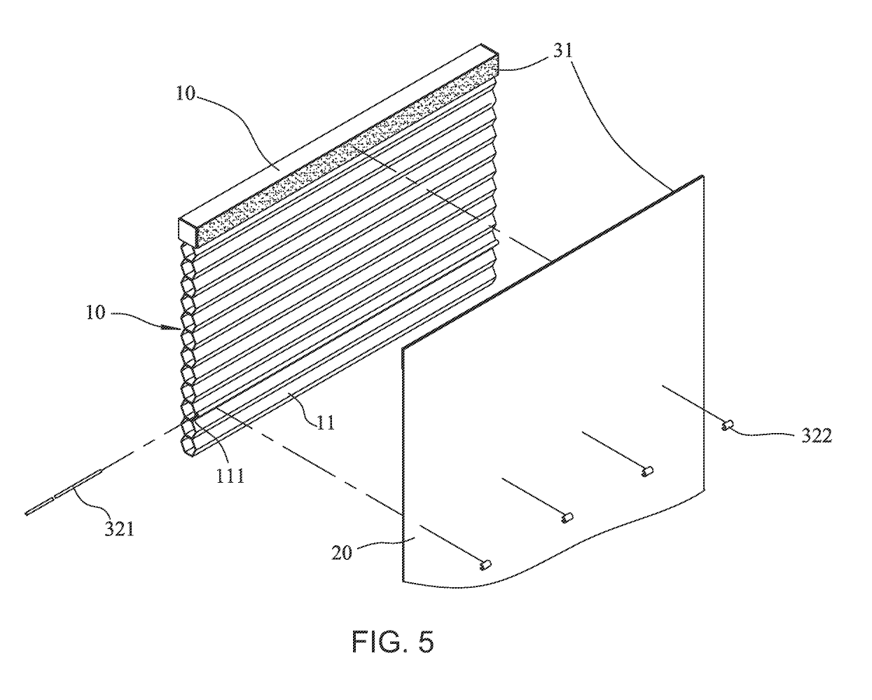

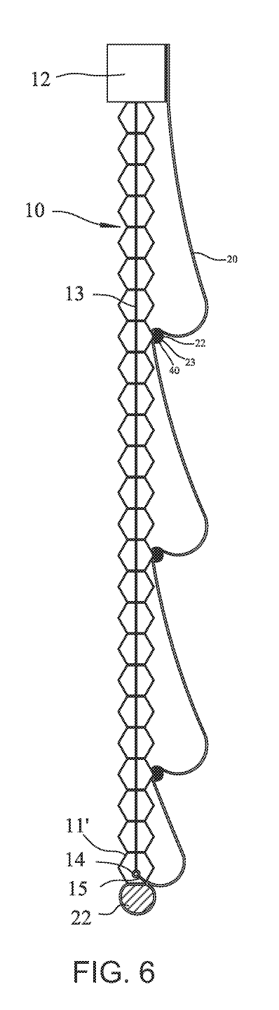

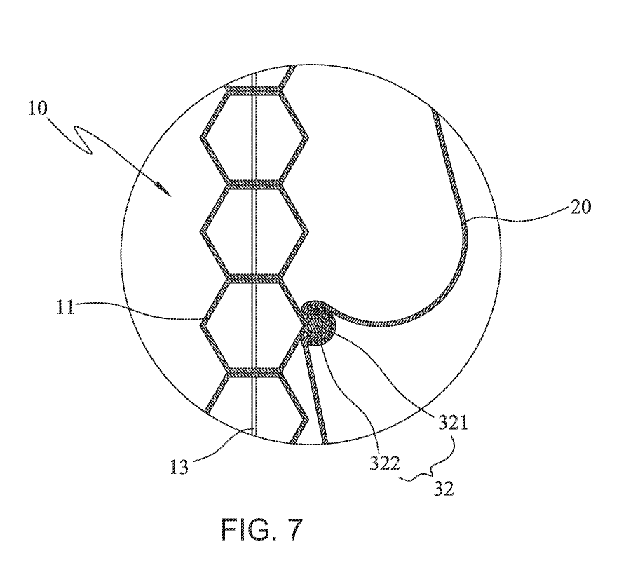

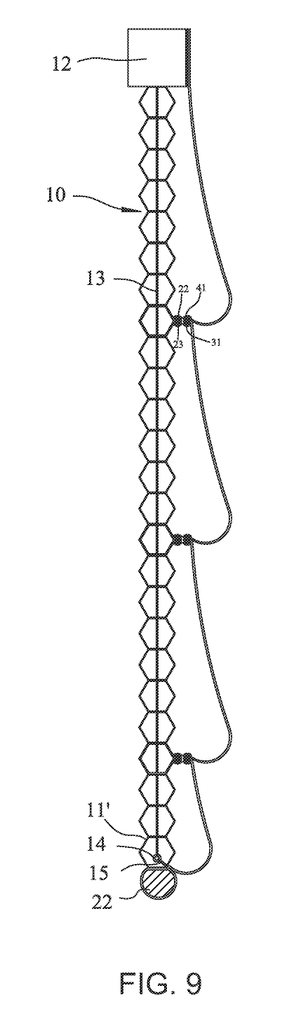

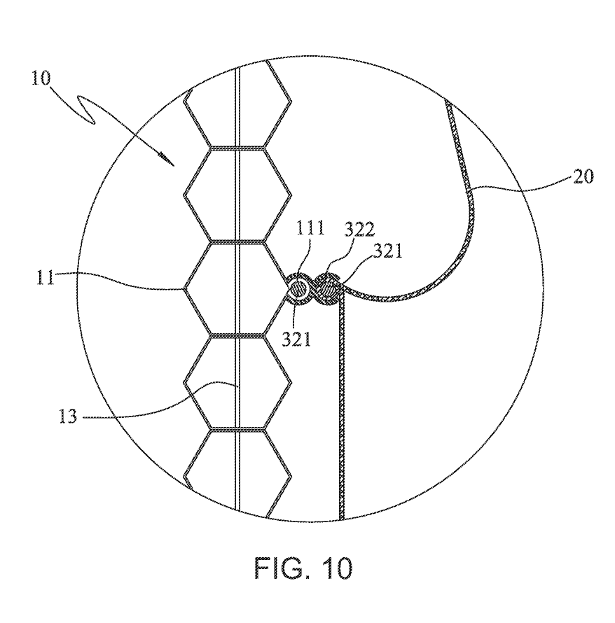

Referring to FIGS. 1 to 10 of the drawings, a window curtain of the present invention is illustrated, wherein the window curtain comprises a blind body 10, a curtain cover 20, and a connecting unit 30.

The blind body 10 comprises a plurality of honeycomb shaped blind elements 11, which is extendable and foldable for operating the blind body 10, an upper supporting mount 12 for coupling at a top of the blind body 10, and a controlling cord 13 downwardly hanging at and extending from the upper supporting mount 11 through each of the honeycomb shaped blind elements 11 in a hidden manner. An opposed end of the controlling cord 13 is connected to a lower end portion of the curtain cover 20 via a ring 14 and a strain 15. Therefore, the honeycomb shaped blind elements 11 preferably equal sized and shaped are able to be controllably operated in response to the operation of lifting up and dropping down the controlling cord 13 for foldably driving each of the honeycomb shaped blind elements 11 between an extended and folded position.

The curtain cover 20 preferably made by fabric material is connected in front of the blind body 10 via the connecting unit 30. An upper end portion of the curtain cover 20 is connected to the upper supporting mount 12, and the lower end portion of the curtain cover 20 is connected to a bottom side of a lowest honeycomb shaped blind element 11′, wherein the lower end portion of the curtain cover 20 is coupling with a weighing object 22 to form a lower supporting base 21, such that a user is able to pull the lower supporting base 21 to actuate the operation of the blind body 10 moving between the extended and folded position, so as to lift or drop the curtain cover 20.

The connecting unit 30 is an intermediate between the curtain cover 20 and the blind body 10, which comprises a first connection part 31 and one or more second connection parts 32, wherein the first connection part 31 is provided between the upper end portion of the curtain cover 20 and the upper supporting mount 12, and the second connection parts 32 are provided between the curtain cover 20 and the honeycomb shaped blind elements 11. Accordingly, the first connection part 31 is preferably embodied as a fastener, such as hook and loop fasteners (Velcro) provided at an outer surface of the upper supporting mount 12 and the upper end portion of the curtain cover 20. The second connection parts 32 having variety designs for operatively connecting the curtain cover 20 to the blind body 10 are embodied as the followings.

Firstly, referring to FIGS. 1 to 3 of the drawings, each of the second connection parts 32 is a sewing structure, which is preferred to evenly sew a middle portion of the curtain cover 20 to the corresponding honeycomb shaped blind elements 11 to form each of the second connection parts 32 at regular intervals. The lower end portion of the curtain cover 20 is embodied to cover the weighing object 22 via sewing to fixedly attach the lower end portion of the curtain cover 20 at the bottom side of the lowest honeycomb shaped blind element 11′.

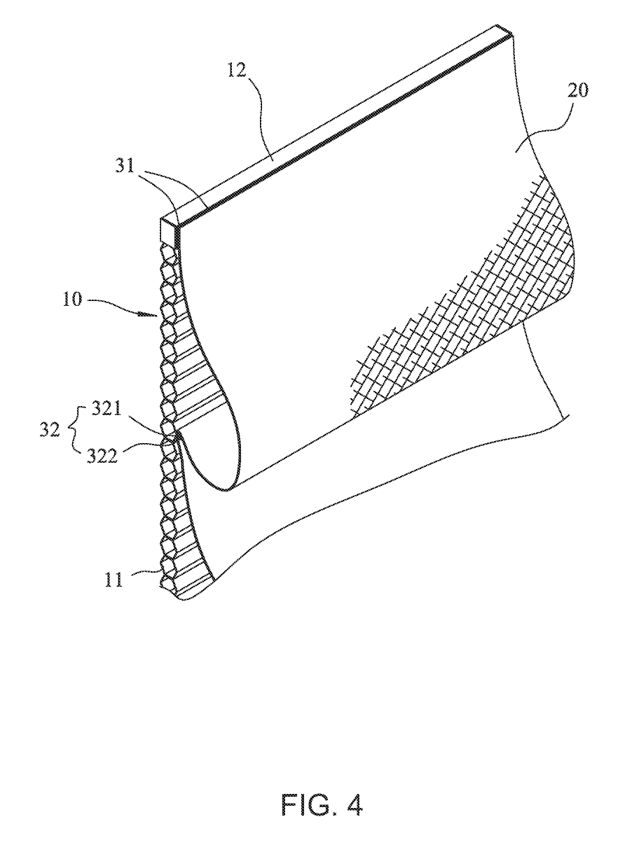

Secondly, as shown in FIGS. 4 to 7 of the drawings, the second connection parts 32 are embodied as one or more elongated rods 321 and one or more corresponding interlocking elements 322. One or more receiving grooves 111 are selectively provided at an outer surface of the honeycomb shaped blind element 11 at regular intervals. The elongated rods 321 are being received within the receiving grooves 111 for being positioned at the blind body 10 at regular intervals. The interlocking elements 322 preferably has a C-shaped cross section, so that the interlocking elements 322 are able to interlock with the elongated rods 321 to sandwich partially of the curtain cover 20 therebetween, so as to attach the middle portion of the curtain cover 20 to the blind body 10. In the preferred embodiment, the lower end portion of the curtain cover 20 is preferred to cover the weighing object 22 via sewing to fixedly attach the lower end portion of the curtain cover 20 at the bottom side of the lowest honeycomb shaped blind element 11′.

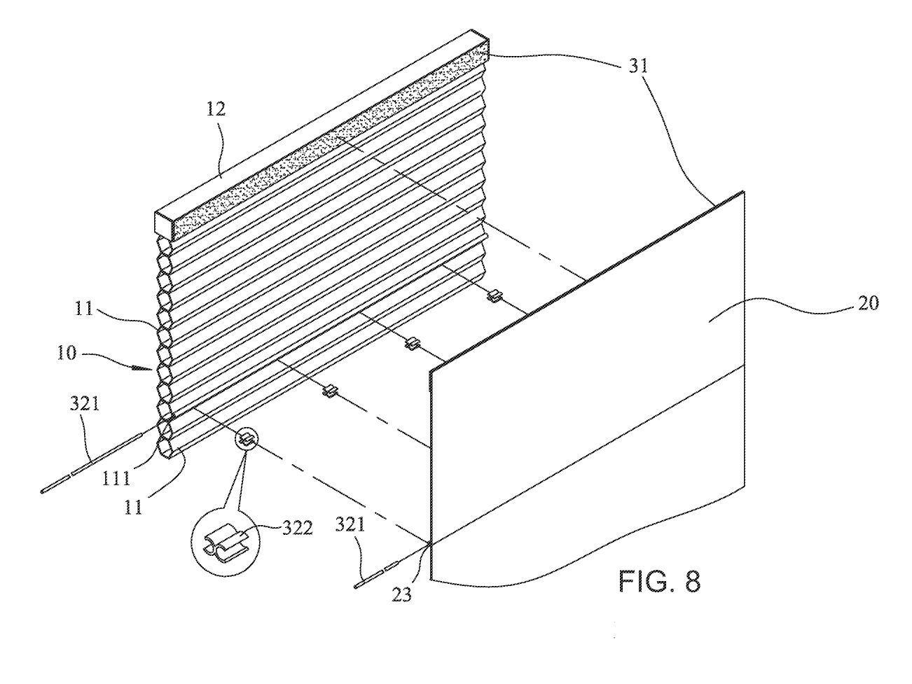

Referring to FIGS. 8 to 10 of the drawings, each of the second connection parts 32 comprising the interlocking elements 322 and the elongated rods 321 for being received within the receiving groove 111 for fixedly positioning to the blind body 10 at regular intervals may further comprises one or more receiving cavity 23, which is evenly spaced apart at the curtain cover 20 in a corresponding position to the receiving grooves 111, so that the receiving cavity 23 is able to receive the elongated rod 321 therewithin. Each of the interlocking elements 32 is embodied as a double symmetrical C-shaped cross section to form two interlocking having two opposed opens for interlocking at the corresponding honeycomb shaped blind elements 11 and the elongated rods 321 at the curtain cover 20, so as to attach the curtain cover 20 to the middle part of the blind body 10. Meanwhile, the lower end portion of the curtain cover 20 is preferred to enclose the weighing object 22 via sewing to fixedly attach the lower end portion of the curtain cover 20 at the bottom side of the lowest honeycomb shaped blind element 11′.

Accordingly, the above mentioned connecting unit 30 is able to attach the curtain cover 20 to the blind body 10 via the second connection parts 32 to define a plurality of sections between the upper and lower end portion of the curtain cover 20. The honeycomb shaped blind elements 11 are connected to form the blind body 10, which is controllably operated via the controlling cord 13 extending through each of the honeycomb shaped blind elements 11 therewithin to form a closed type of blind body 10. The controlling cord 13 is also provided to control the operations of the curtain cover 20 between an opened position when the blind body 10 is at the extended position, and a closed position when the blind body 10 is at the folded position in the hidden manner. Therefore, the curtain cover 20 is being controllably operated via the blind body 10 in a cordless manner, so that the window curtain with the cordless curtain cover 20 is able to prevent the children winding a cord of the traditional curtains on their neck to cause any dangerous thereof, so as to increase the safety of the home environment and to provide the variety of styles of the window curtain.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A window curtain, comprising:
a blind body which comprises a plurality of honeycomb shaped blind elements, an upper supporting mount coupling at a top side of said blind body, and one or more controlling cords downwardly extending from said upper supporting mount through each of said honeycomb shaped blind elements in a hidden manner for controllably operating said honeycomb shaped blind elements, so as to operatively drive said blind body between an extended position and a folded position;
a curtain cover; and
a connecting unit for coupling said curtain cover to said blind body, wherein said connecting unit comprises a first connection part attaching an upper end portion of said curtain cover to said upper supporting mount, and one or more second connection parts selectively attaching said curtain cover in front of said honeycomb shaped blind elements, wherein said second connection parts are spacedly provided between the top and bottom of said blind body to attach a middle portion of said curtain cover to said corresponding honeycomb shaped blind elements therebetween, so as to controllably operate said curtain cover via said blind body between an opened position and a closed position in a cordless manner.

2. The window blind, as recited in claim 1, wherein said second connection parts are evenly spaced from the top to bottom of said blind body at predetermined intervals, so that said curtain cover is evenly attached to said corresponding honeycomb shaped blind elements to define a plurality of sections horizontally arranged from said upper to a lower end portion of said curtain cover.

3. The window blind, as recited in claim 2, wherein a lower end portion of said curtain cover is connected to the bottom of said blind body via sewing.

4. The window blind, as recited in claim 1, wherein a lower end portion of said curtain cover is attached to a bottom side of the lowest honeycomb shaped blind element, wherein a weighing object is provided a the lowest honeycomb shaped blind element to form a lower supporting base of said window curtain, so that said lower supporting base is operatively lifted up to fold up said blind body at said closed position and is operatively dropped down to extend said blind body at said opened position.

5. The window blind, as recited in claim 3, wherein a lower end portion of said curtain cover is attached to a bottom side of the lowest honeycomb shaped blind element, wherein a weighing object is provided a the lowest honeycomb shaped blind element to form a lower supporting base of said window curtain, so that said lower supporting base is operatively lifted up to fold up said blind body at said closed position and is operatively dropped down to extend said blind body at said opened position.

6. The window curtain, as recited in claim 1, wherein said first connection part of said connecting unit comprises a Velcro provided between said upper end portion of said curtain cover and said upper supporting mount for detachably coupling said upper end portion of said curtain cover thereto.

7. The window curtain, as recited in claim 2, wherein said first connection part of said connecting unit comprises a Velcro provided between said upper end portion of said curtain cover and said upper supporting mount for detachably coupling said upper end portion of said curtain cover thereto.

8. The window curtain, as recited in claim 5, wherein said first connection part of said connecting unit comprises a Velcro provided between said upper end portion of said curtain cover and said upper supporting mount for detachably coupling said upper end portion of said curtain cover thereto.

9. The window curtain, as recited in claim 1, wherein each of said second connection parts of said connecting unit comprises one or more rods being selectively positioned at said honeycomb shaped blind elements and one or more interlocking members having C-shaped cross section, wherein each of said interlocking members is interlocking with said corresponding rods to sandwich said curtain cover therebetween, so as to attach said curtain cover to said blind body.

10. The window curtain, as recited in claim 3, wherein each of said second connection parts of said connecting unit comprises one or more rods being selectively positioned at said honeycomb shaped blind elements and one or more interlocking members having C-shaped cross section, wherein each of said interlocking members is interlocking with said corresponding rods to sandwich said curtain cover therebetween, so as to attach said curtain cover to said blind body.

11. The window curtain, as recited in claim 8, wherein each of said second connection parts of said connecting unit comprises one or more rods being selectively positioned at said honeycomb shaped blind elements and one or more interlocking members having C-shaped cross section, wherein each of said interlocking members is interlocking with said corresponding rods to sandwich said curtain cover therebetween, so as to attach said curtain cover to said blind body.

12. The window curtain, as recited in claim 1, wherein each of said second connection parts of said connecting unit comprises one or more rods being selectively positioned at said honeycomb shaped blind elements and said curtain cover, and a plurality of double C-shaped cross section interlocking member for interlocking said rods at said blind body and said curtain cover respectively, so as to operatively connect said curtain cover to said blind body.

13. The window curtain, as recited in claim 3, wherein each of said second connection parts of said connecting unit comprises one or more rods being selectively positioned at said honeycomb shaped blind elements and said curtain cover, and a plurality of double C-shaped cross section interlocking member for interlocking said rods at said blind body and said curtain cover respectively, so as to operatively connect said curtain cover to said blind body.

14. The window curtain, as recited in claim 8, wherein each of said second connection parts of said connecting unit comprises one or more rods being selectively positioned at said honeycomb shaped blind elements and said curtain cover, and a plurality of double C-shaped cross section interlocking member for interlocking said rods at said blind body and said curtain cover respectively, so as to operatively connect said curtain cover to said blind body.

15. The window curtain, as recited in claim 1, wherein each of said second connection parts of said connecting unit is formed via sewing said curtain cover to said corresponding honeycomb shaped blind elements.

16. The window curtain, as recited in claim 3, wherein each of said second connection parts of said connecting unit is formed via sewing said curtain cover to said corresponding honeycomb shaped blind elements.

17. The window curtain, as recited in claim 8, wherein each of said second connection parts of said connecting unit is formed via sewing said curtain cover to said corresponding honeycomb shaped blind elements.

18. The window curtain, as recited in claim 11, wherein said curtain cover is made of fabric material.

19. The window curtain, as recited in claim 14, wherein said curtain cover is made of fabric material.

20. The window curtain, as recited in claim 17, wherein said curtain cover is made of fabric material.
